(19) United States
(12) Patent Application Publication
(10) Pub. No.: US 2020/0164585 A1
(43) Pub. Date: May 28, 2020

(54) METHOD FOR FORMING A DEFINED SURFACE ROUGHNESS IN A REGION OF A COMPONENT FOR A TURBOMACHINE, WHICH COMPONENT IS TO BE MANUFACTURED OR IS MANUFACTURED ADDITIVELY

(71) Applicant: Siemens Aktiengesellschaft, Munich (DE)

(72) Inventor: Ole Geisen, Berlin (DE)

(73) Assignee: Siemens Aktiengesellschaft, Munich (DE)

(21) Appl. No.: 16/630,096

(22) PCT Filed: Jul. 10, 2018
(86) PCT No.: PCT/EP2018/068594

§ 371 Date: Jan. 10, 2020

(30) Foreign Application Priority Data
Aug. 2, 2017 (DE) 10 2017 213 378.3

(51) Int. Cl. B29C 64/393; B29C 64/153; B22F 3/105; B33Y 10/00; B33Y 50/02

(52) U.S. Cl. CPC B29C 64/393; B29C 64/153; B33Y 50/02; B33Y 10/00; B22F 2003/1057; B22F 3/1055

(57) ABSTRACT

A method for forming a defined surface roughness in a region of a component that is to be manufactured or is manufactured additively includes setting an irradiation parameter and/or an irradiation pattern in such a way that a component material is provided with a certain porosity in the region under a surface of the component, which porosity is suitable for causing the defined surface roughness in the component. A corresponding component is also specified.

### CROSS REFERENCE TO RELATED APPLICATIONS

This application is the US National Stage of International Application No. PCT/EP2018/068594 filed 10 Jul. 2018, and claims the benefit thereof. The International Application claims the benefit of German Application No. DE 10 2017 213 378.3 filed 2 Aug. 2017. All of the applications are incorporated by reference herein in their entirety.

### FIELD OF INVENTION

The present invention relates to a method for forming or introducing a defined surface roughness in a region of a component which is to be produced or is produced additively, advantageously from a powder bed. Furthermore, a corresponding component, i.e., comprising the defined surface roughness, is specified.

The surface roughness is advantageously selected and/or defined for identifying, certifying, and/or individualizing the component.

The component is advantageously provided for use in a turbomachine, advantageously in the hot gas path of a gas turbine. The component advantageously comprises or consists of a nickel-based alloy or super alloy, in particular a nickel-based or cobalt-based super alloy. The alloy can be precipitation hardened or precipitation hardenable.

### BACKGROUND OF INVENTION

Generative or additive production methods comprise, for example, as powder bed methods, selective laser melting (SLM) or selective laser sintering (SLS), or electron beam melting (EBM). Laser metal deposition welding (LMD) is also included in the additive methods.

A method for selective laser melting is known, for example, from EP 2 601 006 B1.

Additive manufacturing methods have proven to be particularly advantageous for complex or complicated or filigree designed components, for example, labyrinthine structures, cooling structures, and/or light construction structures. In particular, additive manufacturing is advantageous due to a particularly short chain of process steps, since a production or manufacturing step of a component can be performed directly on the basis of a corresponding CAD file.

Furthermore, additive manufacturing is particularly advantageous for the development or production of prototypes which cannot be produced or cannot be efficiently produced, for example, by means of conventional subtractive or cutting methods or casting technology.

The defined or predetermined surface roughness can be a mean roughness, a squared roughness, a peak-to-valley height, or a mean roughness value.

In contrast to an original buildup of a component proceeding from a corresponding design or CAD file, the option exists of optically measuring a component exemplar to establish the buildup geometry. Correspondingly acquired geometry values can subsequently be simply digitized and then used as the basis for a (further) additive production process and/or a “reprint”. Such a reprint is technically simple, whereby there is a certain risk of plagiarism or “reverse engineering” of components which are predestined for additive production.

A serial number would also be simple to copy, for example, in corresponding replacement parts by way of the additive manufacturing.

In particular in the field of components subjected to high temperatures, a low-quality copy would have disastrous effects, since a copied component was not built up using the provided process parameters, for example, irradiation parameters, and thus has significantly worse mechanical and/or thermomechanical properties. To prevent third-party suppliers, for example, from using expendable parts or replacement parts manufactured via SLM, in particular components having complex geometries are to be unambiguously identifiable.

### SUMMARY OF INVENTION

It is therefore an object of the present invention to specify means, using which an unambiguous identification of additively manufactured components is possible, wherein the components can be characterized, for example, by a forgery-proof identification region.

This object is achieved by the subject matter of the independent patent claims. Advantageous designs are the subject matter of the dependent patent claims.

One aspect of the present invention relates to a method for forming or introducing a defined surface roughness into a region of a component which is to be produced or is produced additively, advantageously from a powder bed.

The mentioned region advantageously represents a surface region or a partial region of the surface of the component.

The described method can also be an additive production method, during which the predetermined surface roughness is generated in the region of the component.

The method furthermore comprises the setting of a process parameter, in particular an irradiation parameter, and/or an irradiation pattern or an irradiation geometry in such a way that a component material is intentionally provided in the region below a surface of the component with a (pre-)defined porosity, which is capable, for example, of inducing or generating the defined surface roughness in the component.

The expression “porosity” can be used synonymously with “density” of the corresponding component material, since molten material from a powder bed necessarily has a defined porosity (even if it is very low).

Similarly, a particularly smooth component surface also has a defined roughness, so that this (smooth) surface can also be characterized by its roughness.

The mentioned irradiation pattern can be composed, for example, of irradiation vectors, according to which an energy beam is scanned or guided during the additive production of the component over a surface made of component material, in particular a powder bed.

By way of the setting of the irradiation parameter, in particular a lateral surface or any other surface of the component can be modified in its roughness in such a way that it is thus made unambiguously identifiable and quasi-forgery-proof in the region.

By way of the setting of the irradiation parameter or an irradiation or exposure geometry, the component can be modified in particular on its lateral surfaces, i.e., on a lateral or jacket surface in parallel to a buildup direction of the component, to generate the predefined or defined surface roughness.

In other words, due to the tailoring of the surface roughness and the introduction thereof into the region, for example, in the case of an expendable component for a gas turbine, it can be unambiguously associated with a producer or even a specific production batch (possibly as a unique specimen).

The defined porosity of the solidified component material is advantageously generated close to the surface in the region of the component, so that a further material layer applied thereon has variations or irregularities in its surface, therefore the defined surface roughness.

In one design, the component material is provided with the porosity in a depth of less than 500 μm below the surface. Due to this design, the component can advantageously be provided with the porosity close to the surface, so that this porosity has effects on the surface structure or the smoothness/roughness of the surface.

The surface advantageously describes the final surface of the component after the completion of the additive buildup.

The depth advantageously describes the shortest distance of the porosity or a pore within the solid body of the finished component to its surface in the region.

The region can describe a volume region and/or surface region.

In one design, the component material is provided with the porosity in a depth between 5 and 15 component layers below the surface.

In one embodiment—to form the defined surface roughness in the region—an irradiation power, for example, a defined power per unit of area, in particular a laser power and/or a scanning or irradiation speed is set in accordance with an expected surface roughness. The expected surface roughness can be a computed or simulated surface roughness.

In one design—to form the defined surface roughness in the region—a high irradiation power, for example, in comparison to a normed or standardized irradiation power, and/or a low scanning speed can be set. A surface roughness for the component can advantageously be tailored or customized in the region by this design—in the course of a powder-bed-based additive production method.

The low scanning speed can also relate to a normed or standardized scanning speed.

In one design—to form the defined surface roughness in the region—a low irradiation power, for example, in comparison to a normed or standardized irradiation power, and/or a high scanning speed can be set. A surface roughness for the component can also advantageously be tailored or customized in the region by this design—in the course of a powder-bed-based additive production method.

In one design—to form the defined surface roughness in the region—a distance of 50 to 500 μm is provided between a surface irradiation vector and a contour irradiation vector. A surface roughness for the component can also advantageously be tailored or customized in the region by this design—in the course of a powder-bed-based additive production method, since the described means induce an elevated probability of a pore formation during the additive buildup.

The expression “contour” or “contour irradiation vector” advantageously relates to an edge or a border of a single material layer to be built up during the production of the component.

In one design—to form the defined surface roughness in the region—surface irradiation vectors extending perpendicularly to a layer contour having a length of less than 500 μm are provided in the corresponding irradiation pattern. This design also offers the advantages of setting a defined surface roughness in the region.

The expression “surface irradiation vector” or vector advantageously denotes in the present case an irradiation or exposure trajectory or a corresponding path, according to which an energy beam, for example a laser beam, is guided over the powder bed to solidify corresponding powder selectively and in accordance with the desired geometry of the component. The energy beam can be guided in this case in a meandering shape over the powder bed to re-melt and solidify the largest possible area. Individual irradiation paths which can be associated with the vector are advantageously only slightly spaced apart from one another in this case, so that a melt pool reaches the entire area of the powder bed to be melted.

The expression “contour irradiation vector” accordingly advantageously denotes an irradiation path which only covers the outer contours, for example, observed in a top view of the component. The purpose of such contour travels is to improve an irradiation or buildup result which is deficient per se after every built-up layer by way of a corresponding contour exposure.

In one design, the porosity can be formed in such a way that it can be detected by means of a radiographic examination, for example, computer tomography or transmission electron microscopy.

In one design, the region represents an identification region.

In one design, the identification region can be automatically analyzed by an identification unit for identifying the component, and/or compared to a database for example.

The region can be, for example, only a small (partial) region and can only represent a small partial surface of the surface of the component. The region can be provided, for example, in a concealed or poorly accessible point.

In one design, the irradiation parameter and/or the irradiation pattern are randomly set, for example, by a computer and/or computer program, to provide the component with a random pore pattern. As an advantage of the random design of the pore pattern and thus the random design of the surface roughness, the component can thus be characterized and/or registered particularly reliably, and thus made quasi-forgery-proof.

A further aspect relates to a component which is provided by the described method with the predefined or defined surface roughness.

A further aspect relates to a computer program and/or a computer program product, comprising commands which, upon execution of the program, for example, by a data processing unit, cause it to set the irradiation parameter and/or the irradiation pattern, as described above.

Designs, features, and/or advantages which refer in the present case to the method can also relate to the component or vice versa.

### BRIEF DESCRIPTION OF THE DRAWINGS

Further details of the invention are described hereinafter on the basis of the figures.

FIG. 1 shows a schematic sectional or side view of an additively produced component.

FIG. 2 shows a simplified schematic sectional or side view of the additively produced component.

FIG. 3 schematically indicates an irradiation pattern for or during the additive production of the component.

### DETAILED DESCRIPTION OF INVENTION

In the exemplary embodiments and figures, identical or identically-acting elements can each be provided with identical reference signs. The illustrated elements and the size ratios thereof to one another are fundamentally not to scale, but rather individual elements can be shown exaggeratedly thick or large-dimensioned for better illustration capability and/or for better comprehension.

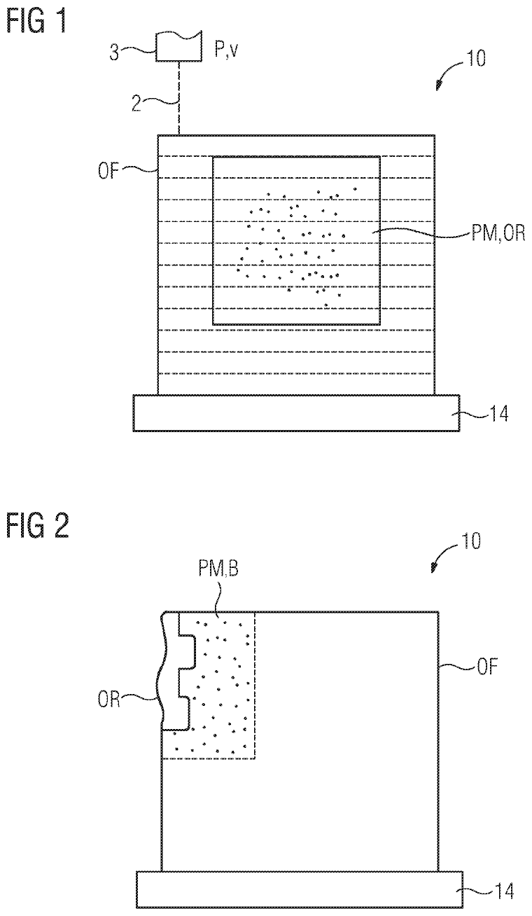

FIG. 1 shows a component 10 in a schematic sectional view. The component 10 is shown in particular during its additive production on a construction panel 14. The corresponding production method is advantageously selective laser melting or electron beam melting. Alternatively, it can be a selective laser sintering method.

The component 10 is advantageously produced layer by layer by selective solidification of layers of a component material (not explicitly identified). The solidification is advantageously performed by an energy beam 2, originating from an irradiation unit 3, advantageously a laser beam source, having a corresponding scanning or guiding optical unit (not explicitly identified). The component comprises a surface OF. The surface OF can comprise, for example, a lateral surface of the component 10.

The component 10 is advantageously a part of a turbomachine, in particular a gas turbine, particularly advantageously a part subjected to a hot gas in usage of the turbine.

The component 10 furthermore comprises a region B. The region B is advantageously a surface region. In the region B, the component 10 was provided with a defined pore pattern PM during its additive production according to the presently described method. The pore pattern PM is indicated in FIG. 1 by a contrast within a solid body of the component. The bright regions within the pore pattern PM can represent, for example, pores or small cavities.

During the additive production, such a pore pattern may be generated or intentionally set, for example, by corresponding selection or corresponding setting of an irradiation parameter, such as a scanning or radiation speed v or, for example, an irradiation power or laser power P. An energy introduction, which can essentially be defined from laser power and scanning speed, is advantageously decisive in this case. With strongly elevated energy introduction, material is vaporized, for example, which can result in pore formation. With excessively low energy introduction, the melt pools can break away or material can partially be inadequately re-melted. Both can be intentionally used to generate a recognizable pattern.

A particularly high irradiation power and/or a low scanning speed, for example, in comparison to a standard or normal method or parameter set, can be set for the additive production process of the component 10 to form the defined porosity and/or defined surface roughness (cf. FIG. 2 below).

Vice versa and with the same result, the porosity or the surface roughness can be set, for example, by a particularly low irradiation power and/or a particularly high scanning speed (in comparison to a standard or normal method or parameter set). In other words, in both described cases a deficient powder solidification can be achieved, which is capable of inducing the desired defined surface roughness.

In each case in relation to a standard or normal process, which induces, for example, a material density of 99.5% or a porosity of 0.5%, respectively, the porosity according to the invention in the region B—for example, due to locally adapted process parameters—can be between 3% and 5%, in particular 4%.

An irradiation power can describe, for example, a laser power of a focused laser beam in a range between 100 W and 500 W, wherein a low irradiation power is located at the lower boundary of the range and a high irradiation power is located at the upper boundary of the range.

A scanning speed can describe, for example, a speed of the energy beam in a range between 100 mm/s and 1000 mm/s, wherein a low scanning speed is located at the lower boundary of the range and a high scanning speed is located at the upper boundary of the range.

The pore pattern PM is advantageously set below the surface OF, so that the surface OF of the component 10 itself is advantageously free of pores and/or cracks.

The component is advantageously provided with the porosity in a depth of less than 500 μm below the surface OF, so that the “subcutaneous” porosity induces or generates a defined surface roughness in the region B (cf. FIG. 2).

The region B is advantageously an identification region, which can be automatically analyzed and/or compared to a database by an identification unit, for example, an optical or optical measuring unit, to identify the component.

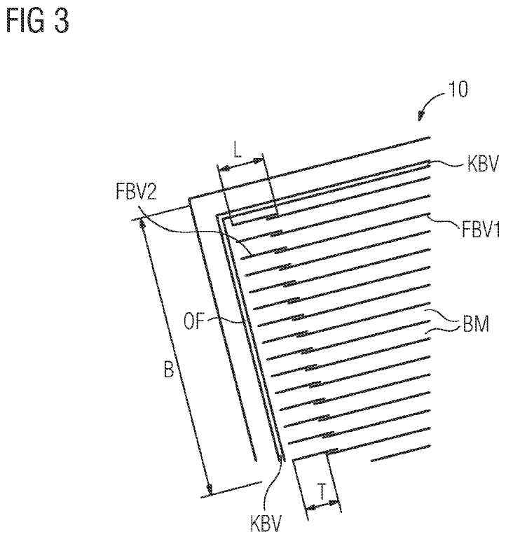

The region B can have, for example, dimensions of 15×15 mm with a depth of approximately 1 mm (cf. FIG. 3). Furthermore, the region is advantageously dimensioned in such a way that it can be penetrated by a radiographic examination and/or material examination, for example, by an x-ray or computer tomography and/or transmission electron microscopy, and the pore pattern PM can thus be registered or recorded.

The region B can—in contrast to what is shown in the illustration of FIG. 1—represent only a particularly small part of the surface OF of the component or describe it. The region B can furthermore denote a concealed and/or a well-accessible surface region of the component. The region B advantageously corresponds to a nonfunctional surface region, for example, not a region which faces toward a flow relevant for the function of the component or is flow-active in usage of the component.

FIG. 2 shows a schematic side view of the component 10 in a simplified illustration. The mentioned defined surface roughness of the component 10 and/or a surface in the region B is provided with the reference sign OR. The region B can be seen at the top left in the view (cf. dashed lines). In the region B, the pore pattern PM or the porosity is indicated by dots. It is provided that the pores are arranged in the “interior” of the component or under the surface OF. Under the surface OF, the pores advantageously induce the surface roughness OR, wherein the surface OF itself is free of pores, however, so as not to impair the component. In particular at temperatures subjected to hot gas, a surface porosity would be disadvantageous, since cracks could result originating therefrom and oxidation or corrosion of the components would be more probable.

FIG. 3 schematically shows a top view or a sectional view of an at least partially additively produced component. Alternatively or additionally, solely an irradiation pattern BM for a layer to be solidified (cf. top view) can be indicated.

The irradiation or exposure pattern BM comprises contour irradiation vectors KBV, which advantageously only irradiate an outline of the component 10 (advantageously observed in a top view of the powder bed), to correct buildup or irradiation errors, and/or to produce a correspondingly smooth surface.

The irradiation or exposure pattern BM furthermore comprises surface irradiation vectors FBV1, FBV2. The surface irradiation vectors FB are approximately horizontal irradiation paths aligned parallel to one another, according to which the energy beam 2 is advantageously guided over the powder bed to remelt and solidify it and/or the component material. A spacing of the surface irradiation vectors FBV (not explicitly identified) is advantageously defined by further irradiation parameters such as the laser power or the powder particle size and/or further parameters.

Furthermore, surface irradiation vectors FBV2 are shown in the left region of the component layer shown, which only have a length L. By way of a selective irradiation of a starting or component material for the component 10 along the surface irradiation vectors FBV2, the advantages according to the invention can be used and the surface roughness OR (cf. FIG. 2) can be set alternatively to the above-described variation or setting of the irradiation parameters. The defined surface roughness OR can advantageously be set in the region B by surface irradiation vectors FBV2 having a length L of less than 500 μm, particularly advantageously less than 300 μm, being provided in an edge region or along a contour of the component 10 as shown in FIG. 3.

The longer surface irradiation vectors FBV1 which are furthermore shown can be associated with an irradiation pattern of the prior art.

Although this is not explicitly identified in FIG. 3, a similar effect, i.e., a similar tailoring or customization of the surface roughness OR can be achieved by a spacing of 50 μm to 500 μm, particularly advantageously between 80 μm and 300 μm, being set or provided between a surface irradiation vector FBV1 (“in skin” irradiation) and a contour irradiation vector KBV in the region B. In this manner, a corresponding pore formation for the pore pattern is induced with increased probability due to the complicated melting and solidification processes during the additive production. Such a situation would arise if the surface irradiation vectors FBV2 were omitted in FIG. 3, but the above-mentioned spacings were set or provided. Then, similarly as in the case of a reduced laser power, for example, a desired porosity or deficient solidification of base or component material would result in the region B.

Furthermore, a depth T is shown in FIG. 3. The depth T advantageously corresponds to a distance perpendicular to the surface OF of the component 10, in which the pore pattern PM is to be provided according to the invention to generate the surface roughness OR. The depth T can describe an amount between 5 and 15 layer thicknesses.

The described pore pattern PM advantageously represents a random pore pattern. It is to be noted that pores arise randomly in the arrangement and dimensions thereof due to an individual and/or random selection of the irradiation parameter and/or the irradiation pattern and thus the component 10 can be made forgery-proof and unambiguously identifiable and/or registered as described. A frame (not explicitly identified) can also be placed around the region B during the buildup, for example, structurally or by visual identification, for the identification or registration.

The surface roughness OR can be set, for example, by a computer automatically, by corresponding selection of irradiation pattern and/or irradiation parameter, which can be taken, for example, from a database. Furthermore, the surface roughness OR can be acquired, for example, by optical measuring or scanning methods.

It can also be provided according to the invention that the defined surface roughness is applied in or on an already prefinished component, for example, to characterize, identify, or certify it later for a defined producer.

The invention is not restricted thereto by the description on the basis of the exemplary embodiments, but rather comprises every novel feature and every combination of features. This includes in particular every combination of features in the patent claims, even if this feature or this combination is itself not explicitly specified in the patent claims or exemplary embodiments.

1.-12. (canceled)

13. A method for forming a defined surface roughness in a region of a component which is to be produced or is produced additively, comprising:
setting of an irradiation parameter and/or an irradiation pattern in such a way that a component material in the region below a surface of the component is provided with a defined porosity;
wherein, to form the defined surface roughness in the region,
setting an irradiation power or a laser power in accordance with an expected surface roughness, and/or
setting a scanning speed is set in accordance with an expected surface roughness.

14. The method as claimed in claim 13,
wherein the component material is provided with the defined porosity in a depth of less than 500 μm below the surface.

15. The method as claimed in claim 13,
wherein the component material is provided with the defined porosity in a depth between 5 and 15 layer thicknesses below the surface.

16. The method as claimed in claim 15,
wherein, to form the defined surface roughness in the region, a high irradiation power, and a low scanning speed is set.

17. The method as claimed in claim 13,
wherein, to form the defined surface roughness in the region, a low irradiation power, and a high scanning speed is set.

18. The method as claimed in claim 13,
wherein, to form the defined surface roughness in the region, a spacing of 50 to 500 μm is provided between a surface irradiation vector and a contour irradiation vector.

19. The method as claimed in claim 13,
wherein, to form the defined surface roughness in the region, surface irradiation vectors extending perpendicularly to a layer contour and having a length of less than 500 μm are provided.

20. The method as claimed in claim 13,
wherein the defined porosity is formed in such a way that it detectable by means of a radiographic examination.

21. The method as claimed in claim 13,
wherein the region represents an identification region, which is automatically analyzed by an identification unit to identify the component.

22. The method as claimed in claim 13,
wherein the irradiation parameter and/or the irradiation pattern are set randomly by a computer, to provide the component with a random pore pattern.

23. A component which is provided in the region with the defined surface roughness according to the method as claimed in claim 13.
